(19) United States
(12) Patent Application Publication
(10) Pub. No.: US 2024/0371409 A1
(43) Pub. Date: Nov. 7, 2024

(54) METHOD FOR GENERATING SUBTITLE, ELECTRONIC DEVICE, AND COMPUTER-READABLE STORAGE MEDIUM

(71) Applicant: Tencent Music Entertainment Technology (Shenzhen) Co., Ltd., Shenzhen (CN)

(72) Inventors: Yue ZHANG, Shenzhen (CN); Shiyue Lai, Shenzhen (CN); Junxin Huang, Shenzhen (CN); Zhi Dong, Shenzhen (CN); Tao Jiang, Shenzhen (CN)

(73) Assignee: Tencent Music Entertainment Technology (Shenzhen) Co., Ltd., Shenzhen (CN)

(21) Appl. No.: 18/750,666

(22) Filed: Jun. 21, 2024

Related U.S. Application Data
(63) Continuation of application No. PCT/CN2022/123575, filed on Sep. 30, 2022.

(30) Foreign Application Priority Data
Dec. 22, 2021 (CN) 202111583584.6

(51) Int. Cl. G11B 27/036; G06F 16/635; G06T 7/70; G06T 11/20; G06T 11/60; G10L 15/26; G10L 25/18; G10L 25/57

(52) U.S. Cl. CPC G11B 27/036; G06F 16/635; G06T 7/70; G06T 11/203; G06T 11/60; G10L 15/26; G10L 25/18; G10L 25/57; G06T 2207/10016

(57) ABSTRACT

A method for generating a subtitle, an electronic device, and a computer-readable storage medium are provided. The method includes the following. A song audio signal is extracted from target video data. A target song corresponding to the song audio signal and a time position of the song audio signal in the target song are determined. Lyric information corresponding to the target song is obtained, where the lyric information includes one or more lyrics, and the lyric information further includes a starting time and duration of each lyric and/or a starting time and duration of each word in each lyric. A subtitle is rendered in the target video data based on the lyric information and time position to obtain target video data with a subtitle.

This application is a continuation under 35 U.S.C. § 120 of International Application No. PCT/CN2022/123575, filed Sep. 30, 2022, which claims priority under 35 U.S.C. § 119 (a) and/or PCT Article 8 to Chinese Patent Application Serial No. 202111583584.6, filed Dec. 22, 2021. The entire disclosures of both International Application No. PCT/CN2022/123575 and Chinese Patent Application Serial No. 202111583584.6 are hereby incorporated by reference.

### TECHNICAL FIELD

The disclosure relates to the field of computer technology, and in particular to a method for generating a subtitle, an electronic device for generating a subtitle, and a non-transitory computer-readable storage medium.

### BACKGROUND

With the development of communication network technology and computer technology, people can share music short videos more conveniently, so that making music short videos has become popular and favored by people. After filmed videos are edited together and a suitable piece of music is added to the video, a music short video is generated. However, it is troublesome to add a subtitle displayed synchronously with the music to the music short video.

The existing manner for generating a subtitle for a music short video is mainly manual addition. That is, by means of professional editing software, people manually find a time position of each sentence in lyrics on a timeline of an audio short video, and then add a subtitle to the music short video one by one according to the time position on the timeline. This manual addition manner is not only time-consuming, and inefficient in generating the subtitle, but also has high labor costs.

### SUMMARY

In a first aspect, the disclosure provides a method for generating a subtitle, and the method includes the following. A song audio signal is extracted from target video data. A target song corresponding to the song audio signal and a time position of the song audio signal in the target song are determined. Lyric information corresponding to the target song is obtained, where the lyric information includes one or more lyrics, and the lyric information further includes a starting time and duration of each lyric and/or a starting time and duration of each word in each lyric. Based on the lyric information and the time position, a subtitle is rendered in the target video data to obtain target video data with a subtitle.

The disclosure provides an electronic device including a processor, a memory, and a communication interface. The processor is connected to the memory and the communication interface. The communication interface is configured to provide network communication functions. The memory is configured to store program codes. The processor is configured to invoke the program codes to perform the following. A song audio signal is extracted from target video data. A target song corresponding to the song audio signal and a time position of the song audio signal in the target song are determined. Lyric information corresponding to the target song is obtained, where the lyric information includes one or more lyrics, and the lyric information further includes a starting time and duration of each lyric and/or a starting time and duration of each word in each lyric. Based on the lyric information and the time position, a subtitle is rendered in the target video data to obtain target video data with a subtitle.

The disclosure provides a non-transitory computer-readable storage medium storing a computer program. The computer program includes program instructions. The program instructions, when executed by a processor, are operable to perform the following. A song audio signal is extracted from target video data. A target song corresponding to the song audio signal and a time position of the song audio signal in the target song are determined. Lyric information corresponding to the target song is obtained, where the lyric information includes one or more lyrics, and the lyric information further includes a starting time and duration of each lyric and/or a starting time and duration of each word in each lyric. Based on the lyric information and the time position, a subtitle is rendered in the target video data to obtain target video data with a subtitle.

### BRIEF DESCRIPTION OF THE DRAWINGS

In order to more clearly illustrate technical solutions of embodiments of the disclosure, the following briefly introduces the drawings required for describing the embodiments.

FIG. 1 is a schematic diagram of an architecture of a system for generating a subtitle provided in embodiments of the disclosure.

FIG. 2 is a schematic flow chart of a method for generating a subtitle provided in embodiments of the disclosure.

FIG. 3 is a schematic diagram illustrating a speech spectrogram provided in embodiments of the disclosure.

FIG. 4 is a schematic structural diagram of a song fingerprint database provided in embodiments of the disclosure.

FIG. 5 is a schematic structural diagram of a lyric database provided in embodiments of the disclosure.

FIG. 6 is a diagram illustrating an application scenario of subtitle rendering provided in embodiments of the disclosure.

FIG. 7 is a schematic diagram of an embodiment provided in embodiments of the disclosure.

FIG. 8 is a schematic diagram of another embodiment provided in embodiments of the disclosure.

FIG. 9 is a schematic structural diagram of an apparatus for generating a subtitle provided in embodiments of the disclosure.

FIG. 10 is a schematic structural diagram of an electronic device provided in embodiments of the disclosure.

### DETAILED DESCRIPTION

Technical solutions of embodiments of the disclosure will be described clearly and completely below with reference to the accompanying drawings in the embodiments of the disclosure. Apparently, embodiments described herein are some embodiments, rather than all embodiments, of the disclosure. Based on the embodiments of the disclosure, all other embodiments obtained by those of ordinary skill in the art without creative effort shall fall within the protection scope of the disclosure.

The disclosure provides a method for generating a subtitle, an electronic device, and a non-transitory computer-readable storage medium, which can automatically generate a subtitle for a music short video, improve the efficiency of subtitle generation, and reduce labor costs.

In a first aspect, the disclosure provides a method for generating a subtitle, and the method includes the following. A song audio signal is extracted from target video data. A target song corresponding to the song audio signal and a time position of the song audio signal in the target song are determined. Lyric information corresponding to the target song is obtained, where the lyric information includes one or more lyrics, and the lyric information further includes a starting time and duration of each lyric and/or a starting time and duration of each word in each lyric. Based on the lyric information and the time position, a subtitle is rendered in the target video data to obtain target video data with a subtitle.

Based on the method described in the first aspect, complete lyric information of the target song corresponding to the song audio signal and the time position of the song audio signal in the target song can be automatically determined. According to the complete lyric information and the time position, the subtitle can be automatically rendered in the target video data, which can improve the efficiency of subtitle generation and reduce labor costs.

In a possible embodiment, the target song corresponding to the song audio signal and the time position of the song audio signal in the target song are determined as follows. The song audio signal is converted into speech spectrum information. Based on a peak point in the speech spectrum information, fingerprint information of the song audio signal is determined. The fingerprint information of the song audio signal is matched with song fingerprint information in a song fingerprint database to determine the target song corresponding to the song audio signal and the time position of the song audio signal in the target song.

Based on the possible embodiment, the target song corresponding to the song audio signal and the time position of the song audio signal in the target song can be accurately determined.

In a possible embodiment, the fingerprint information of the song audio signal is matched with the song fingerprint information in the song fingerprint database as follows. Based on a song popularity ranking order corresponding to the song fingerprint information in the song fingerprint database, the fingerprint information of the song audio signal is matched with the song fingerprint information in the song fingerprint database in descending order of popularity.

Based on the possible embodiment, matching efficiency can be greatly improved, and time required for matching can be reduced.

In a possible embodiment, the method further includes the following. Gender of a singer of the song audio signal is identified. The fingerprint information of the song audio signal is matched with the song fingerprint information in the song fingerprint database as follows. The fingerprint information of the song audio signal is matched with song fingerprint information corresponding to the gender of the singer in the song fingerprint database.

Based on the possible embodiment, song fingerprints in the song fingerprint database can be classified by gender, and the song audio signal is compared with a corresponding category, so that the matching efficiency is greatly improved, and the time required for matching is reduced.

In a possible embodiment, based on the lyric information corresponding to the target song and the time position of the song audio signal in the target song, the subtitle is rendered in the target video data to obtain the target video data with the subtitle as follows. Based on the lyric information corresponding to the target song and the time position of the song audio signal in the target song, a subtitle content corresponding to the song audio signal and time information of the subtitle content in the target video data are determined. Based on the subtitle content corresponding to the song audio signal and the time information of the subtitle content in the target video data, the subtitle is rendered in the target video data to obtain the target video data with the subtitle.

Based on the possible embodiment, target lyric information corresponding to the song audio signal can be converted into the subtitle content corresponding to the song audio signal, and the time position of the song audio signal in the target song can be converted into time information in the target video data. Therefore, in the process of subtitle generation, a generated subtitle is more consistent with the song audio signal and is more accurate.

In a possible embodiment, based on the subtitle content corresponding to the song audio signal and the time information of the subtitle content in the target video data, the subtitle is rendered in the target video data to obtain the target video data with the subtitle as follows. The subtitle content is drawn as one or more subtitle pictures based on a target font configuration file. Based on the one or more subtitle pictures and the time information of the subtitle content in the target video data, the subtitle is rendered in the target video data to obtain the target video data with the subtitle.

In a possible embodiment, based on the one or more subtitle pictures and the time information of the subtitle content in the target video data, the subtitle is rendered in the target video data to obtain the target video data with the subtitle as follows. Position information of the one or more subtitle pictures in a video frame of the target video data is determined. Based on the one or more subtitle pictures, the time information of the subtitle content in the target video data, and the position information of the one or more subtitle pictures in the video frame of the target video data, the subtitle is rendered in the target video data to obtain target video data with the subtitle.

Based on the possible embodiment, a position of a subtitle picture in the video frame of the target video data is determined so that a corresponding subtitle content is accurately rendered at a corresponding time.

In a possible embodiment, the method further includes the following. The target video data and a font configuration file identifier sent by a terminal device are received. The target font configuration file corresponding to the font configuration file identifier is obtained from multiple preset font configuration files.

Based on the possible embodiment, a user can select a font configuration file on the terminal device, and the terminal device can report a font configuration file selected by the user. Therefore, based on the possible embodiment, the user can flexibly select the style of the subtitle.

In a second aspect, the disclosure provides an apparatus for generating a subtitle, the device includes an extracting module, a determining module, and a rendering module. The extracting module is configured to extract a song audio signal from target video data. The determining module is configured to determine a target song corresponding to the song audio signal and a time position of the song audio signal in the target song. The determining module is further configured to obtain lyric information corresponding to the target song, where the lyric information includes one or more lyrics, and the lyric information further includes a starting time and duration of each lyric and/or a starting time and duration of each word in each lyric. The rendering module is configured to render a subtitle in the target video data based on the lyric information and the time position to obtain target video data with a subtitle.

In a possible embodiment, the determining module is further configured to convert the song audio signal into speech spectrum information. The determining module is further configured to determine fingerprint information of the song audio signal based on a peak point in the speech spectrum information. The determining module is further configured to match the fingerprint information of the song audio signal with song fingerprint information in a song fingerprint database to determine the target song corresponding to the song audio signal and the time position of the song audio signal in the target song.

In a possible embodiment, the determining module is further configured to match the fingerprint information of the song audio signal with the song fingerprint information in the song fingerprint database in descending order of popularity based on a song popularity ranking order corresponding to the song fingerprint information in the song fingerprint database.

In a possible embodiment, the determining module is further configured to identify gender of a singer of the song audio signal. In terms of matching the fingerprint information of the song audio signal with the song fingerprint information in the song fingerprint database, the determining module is configured to match the fingerprint information of the song audio signal with the song fingerprint information corresponding to the gender of the singer in the song fingerprint database.

In a possible embodiment, the determining module is further configured to determine a subtitle content corresponding to the song audio signal and the time information of the subtitle content in the target video data based on the lyric information corresponding to the target song and the time position of the song audio signal in the target song. The rendering module is further configured to render the subtitle in the target video data based on the subtitle content corresponding to the song audio signal and the time information of the subtitle content in the target video data to obtain the target video data with the subtitle.

In a possible embodiment, the rendering module is further configured to draw the subtitle content as one or more subtitle pictures based on a target font configuration file. The rendering module is further configured to render the subtitle in the target video data based on the one or more subtitle pictures and the time information of the subtitle content in the target video data to obtain the target video data with the subtitle.

In a possible embodiment, the rendering module is further configured to determine position information of the one or more subtitle pictures in a video frame of the target video data. The rendering module is further configured to render the subtitle in the target video data based on the one or more subtitle pictures, the time information of the subtitle content in the target video data, and the position information of the one or more subtitle pictures in the video frame of the target video data, to obtain target video data with the subtitle.

In a possible embodiment, the determining module is further configured to receive the target video data and a font configuration file identifier sent by a terminal device. The determining module is further configured to obtain the target font configuration file corresponding to the font configuration file identifier from multiple preset font configuration files.

The disclosure provides an electronic device including a processor, a memory, and a communication interface. The processor is connected to the memory and the communication interface. The communication interface is configured to provide network communication functions. The memory is configured to store program codes. The processor is configured to invoke the program codes to perform the method described in the first aspect.

The disclosure provides a non-transitory computer-readable storage medium storing a computer program. The computer program includes program instructions. The program instructions, when executed by a processor, are operable to perform the method described in the first aspect.

A system for generating a subtitle in embodiments of the disclosure is introduced as follows.

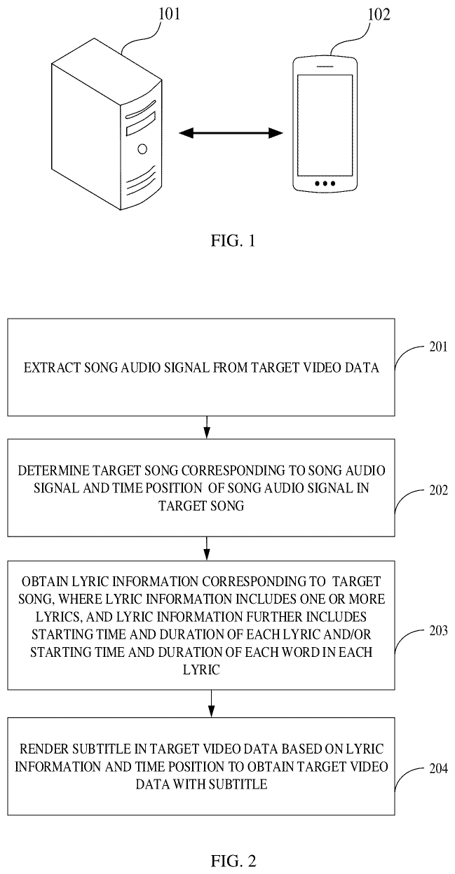

Reference is made to FIG. 1 which is a schematic diagram of an architecture of a system for generating a subtitle provided in embodiments of the disclosure. The system for generating a subtitle mainly includes an apparatus 101 for generating a subtitle and a terminal device 102. The apparatus 101 for generating a subtitle and the terminal device 102 can be connected via a network.

The terminal device 102 is a device where a client of a playing platform is installed, and is a device with a video playing function, including but not limited to a smart phone, a tablet computer, a laptop, etc. The apparatus 101 for generating a subtitle is a background device of the playing platform or a chip in the background device, which can generate a subtitle for a video. For example, the apparatus 101 for generating a subtitle may be an independent physical server, a server cluster or distributed system including multiple physical servers, or a cloud server that provides basic cloud computing services such as cloud services, cloud databases, cloud computing, cloud functions, cloud storage, network services, cloud communications, middleware services, domain name services, security services, content delivery network (CDN), big data, and artificial intelligence (AI) platforms.

A user can select video data (such as a user-made music short video) that needs subtitle generation on the terminal device 102, and upload the video data to the apparatus 101 for generating a subtitle. After receiving the video data uploaded by the user, the apparatus 101 for generating a subtitle automatically generates a subtitle for the video data. The apparatus 101 for generating a subtitle can extract fingerprint information of a song audio signal in the video data, and obtain an identifier (such as a song name and/or a song index number, etc.) of a target song corresponding to the song audio signal and a time position of the song audio signal in the target song by matching the fingerprint information of the song audio signal with song fingerprint information in a song fingerprint database included in the apparatus 101 for generating a subtitle. The apparatus 101 for generating a subtitle can automatically render the subtitle in the video data based on lyric information of the target song and the time position of the song audio signal in the target song to obtain video data with the subtitle.

It is noted that there may be one or more terminal devices 102 and apparatuses 101 for generating a subtitle in the scenario illustrated in FIG. 1, which is not limited in the disclosure. For the convenience of description, for example, the apparatus 101 for generating a subtitle is taken as a server in the following, and the method for generating a subtitle provided in the embodiments of the disclosure is further illustrated.

Reference is made to FIG. 2 which is a schematic flow chart of a method for generating a subtitle provided in embodiments of the disclosure. The method for generating a subtitle includes operations at 201 to 204 as follows.

At 201, a server extracts a song audio signal from target video data.

The target video data may include video data shot and edited by a user, video data downloaded by the user on the Internet, or video data that needs to be rendered with a subtitle and directly selected by the user on the Internet. The song audio signal may include a song audio signal corresponding to background music carried by the target video data, or may include music added by the user for the target video data.

Optionally, the user may upload the video data via a terminal device. When the server detects uploaded video data, the server extracts the song audio signal from the video data and generates a subtitle for the video data according to the song audio signal.

Optionally, when the server detects the uploaded video data, the server first determines whether the video data already contains a subtitle. When it is determined that the video data does not contain a subtitle, the server extracts the song audio signal from the video data and generates a subtitle for the video data according to the song audio signal.

Optionally, the user may select an option of automatic subtitle generation when uploading data on the terminal device. When the terminal device uploads the video data to the server, the terminal device also uploads instruction information for instructing the server to generate the subtitle for the video data. After the server detects the uploaded video data and the instruction information, the server extracts the song audio signal from the video data and generates the subtitle for the video data according to the song audio signal.

At 202, the server determines a target song corresponding to the song audio signal and a time position of the song audio signal in the target song.

Optionally, the target song corresponding to the song audio signal may include a complete song corresponding to the song audio signal. It can be understood that the song audio signal is one or more segments of the target song.

Optionally, the time position of the song audio signal in the target song may be represented by a starting position of the song audio signal in the target song. For example, the target song is a 3-minute song, and the song audio signal starts from the 1st minute in the target song, then the time position of the song audio signal in the target song may be represented by a starting position (01:00) of the song audio signal in the target song.

Optionally, the time position of the song audio signal in the target song may be represented by a starting position and an ending position of the song audio signal in the target song. For example, the target song is a 3-minute song, and the song audio signal corresponds to a segment from 1 minute to 1 minute 30 seconds in the target song, then the time position of the song audio signal in the target song may be represented by a starting position and an ending position (01:00, 01:30) of the song audio signal in the target song.

In a possible embodiment, by comparing the fingerprint information of the song audio signal with pre-stored song fingerprint information, the target song corresponding to the song audio signal and the time position of the song audio signal in the target song can be determined.

In a possible embodiment, the server determines the target song corresponding to the song audio signal and the time position of the song audio signal in the target song specifically as follows. The server converts the song audio signal into speech spectrum information. The server determines fingerprint information of the song audio signal based on a peak point in the speech spectrum information. The server matches the fingerprint information of the song audio signal with song fingerprint information in a song fingerprint database to determine the target song corresponding to the song audio signal and the time position of the song audio signal in the target song. Based on the possible embodiment, the target song corresponding to the song audio signal and the time position of the song audio signal in the target song can be accurately determined.

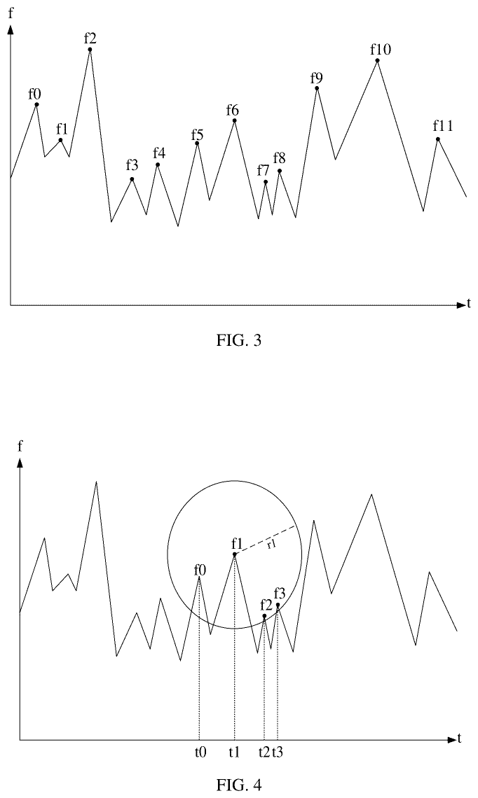

Optionally, the speech spectrum information may be a speech spectrogram. The speech spectrum information has two dimensions: a time dimension and a frequency dimension, that is, the speech spectrum information includes a correspondence between each time point of the song audio signal and the frequency of the song audio signal. The peak point in the speech spectrum information represents a most representative frequency value of a song at each moment, and each peak point corresponds to an index (f, t) including frequency and time. For example, as illustrated in FIG. 3 which is a speech spectrogram, the horizontal axis of the speech spectrogram represents time, and the vertical axis represents frequency. f0˜f11 in FIG. 3 are multiple peaks of the speech spectrogram.

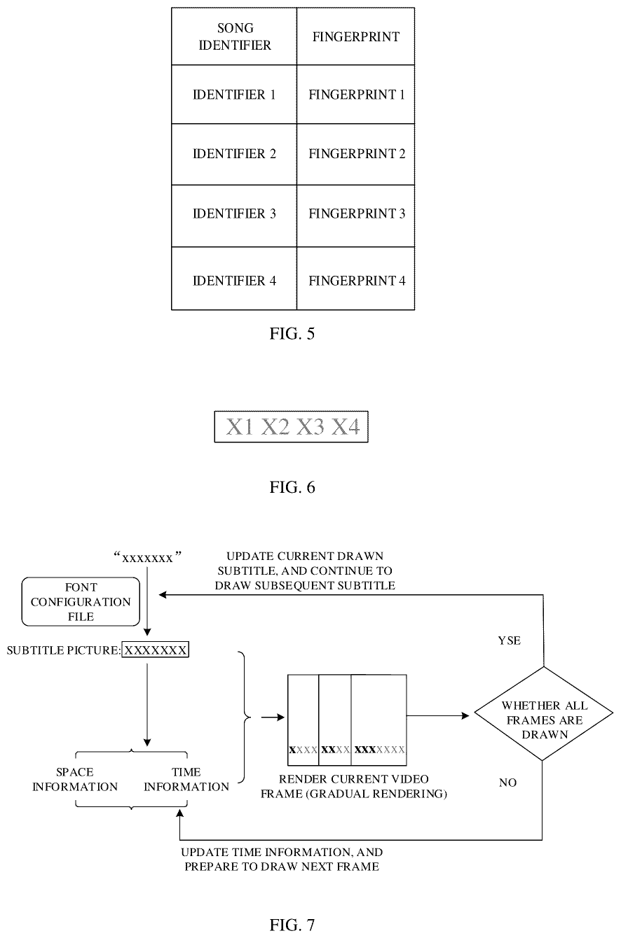

Optionally, the target song corresponding to the song audio signal may be determined as follows. A song identifier corresponding to the song audio signal is first determined via a mapping table (as illustrated in FIG. 5) between fingerprints and song identifiers in the song fingerprint database, and then the target song is determined via the song identifier.

In a possible embodiment, the server determines the fingerprint information of the song audio signal based on the peak point in the speech spectrum information specifically as follows. The server selects multiple neighboring peak points from each peak point, and combines the neighboring peak points to obtain a neighboring peak point set. The server determines the fingerprint information of the song audio signal based on one or more neighboring peak point sets.

Optionally, each neighboring peak point set can be encoded to obtain sub-fingerprint information, and the sub-fingerprint information of each neighboring peak point set is merged to obtain the fingerprint information of the song audio signal. The manner of selecting neighboring peak points may be as follows. Any peak point in the speech spectrum information is taken as the center of a circle, and a preset distance threshold is taken as the radius, to determine the coverage of the circle. All peak points which are within the coverage range of the circle and are corresponding to time points that are greater than a time point of the center of the circle are combined into a neighboring peak point set. The neighboring peak point set only includes peak points which are within a certain range and are corresponding to the time points that are greater than the time point of the center of the circle, that is, peak points which are corresponding to time points later than the time point of the center of the circle.

For example, the above-mentioned neighboring peak point set is further explained with reference to FIG. 4. For the speech spectrum information illustrated in FIG. 3, the horizontal axis represents time, and the vertical axis represents frequency. A frequency corresponding to t0 is f0. A frequency corresponding to t1 is f1. A frequency corresponding to t2 is f2. A frequency corresponding to t3 is f3. The size relationship of the four time points t0, t1, t2, and t3 is: t3>t2>t1>t0. A peak point (t1, f1) in FIG. 4 is taken as the center of the circle, and a preset distance (radius) is taken as r1, so that the coverage range is the circle illustrated in FIG. 4. As illustrated in FIG. 4, peak points (t0, f0), (t1, f1), (t2, f2), and (t3, f3) are all within the circular coverage range. However, because t0 is less than t1, (t0, f0) does not belong to a neighboring peak point set which takes the peak point (t1, f1) as the center of the circle. The circle with f1 as the center and r1 as the radius corresponds to the neighboring peak point set including {(t1, f1), (t2, f2), (t3, f3)}. By taking a peak as the center and the preset distance as the radius, the neighboring peak point set is obtained, so as to avoid repeated sub-fingerprint information.

In a possible embodiment, a hash algorithm may be used to encode the neighboring peak point set into fingerprint information. For example, the peak point that is taken as the center of the circle is represented as (f0, t0), and n neighboring peak points for the peak point are represented as (f1, t1), (f2, t2), . . . , (fn, tn), then (f0, t0) is combined with each of the neighboring peak points to obtain pairs of combined information, for example, (f0, f1, t1-t0), (f0, f2, t2-t0), . . . , (f0, fn, tn-t0). Then the combined information is encoded into a sub-fingerprint in a manner of hash coding. All sub-fingerprints may be merged as the fingerprint information of the song audio signal.

Based on the possible embodiment, the neighboring peak point set can be encoded into the fingerprint information by using the hash algorithm, thereby reducing the possibility of fingerprint information collision.

In a possible embodiment, the server matches the fingerprint information of the song audio signal with the song fingerprint information in the song fingerprint database specifically as follows. The server matches the fingerprint information of the song audio signal with the song fingerprint information in the song fingerprint database in descending order of popularity based on a song popularity ranking order corresponding to the song fingerprint information in the song fingerprint database.

In the song popularity ranking order, the higher the ranking, the more popular the song. The user may use a popular song as background music when making the audio short video, so the fingerprint information of the song audio signal can be matched with fingerprint information of high-popularity-ranked songs first, which is conducive to quickly determining the target song corresponding to the song audio signal and the time position of the song audio signal in the target song.

Based on the possible embodiment, the matching efficiency can be greatly improved, and the time required for matching can be reduced.

In a possible embodiment, the server matches the fingerprint information of the song audio signal with the song fingerprint information in the song fingerprint database specifically as follows. The server identifies a gender of a singer of the song audio signal. The server matches the fingerprint information of the song audio signal with the song fingerprint information in the song fingerprint database specifically as follows. The server matches the fingerprint information of the song audio signal with song fingerprint information corresponding to the gender of the singer in the song fingerprint database.

The gender of the singer includes male/female. First, the gender of the singer of the song audio signal in the target video data is determined. Then, according to the gender of the singer of the song audio signal, the fingerprint information of the song audio signal is matched with a corresponding gender song set in the song fingerprint database. In other words, if the gender of the singer of the song audio signal is female, during matching in the song fingerprint database, the fingerprint information of the song audio signal is only matched with a female singer song set in the song fingerprint database, and does not need to be matched with a male singer song set. Similarly, when the gender of the singer of the song audio signal extracted from the target video data is male, during matching in the song fingerprint database, the fingerprint information of the song audio signal is only matched with the male singer song set in the song fingerprint database, and does not no need to be matched with the female singer song set. This is conducive to quickly determining the target song corresponding to the song audio signal and the time position of the song audio signal in the target song.

Based on the possible embodiment, the matching efficiency can be greatly improved, and the time required for matching can be reduced.

At 203, the server obtains lyric information corresponding to the target song, where the lyric information includes one or more lyrics, and the lyric information further includes a starting time and duration of each lyric and/or a starting time and duration of each word in each lyric.

In embodiments of the disclosure, the server may obtain the lyric information corresponding to the target song from a lyric database. The lyric information may include one or more of the lyrics, and the lyric information further includes the starting time and the duration of each lyric and/or the starting time and the duration of each word in each lyric.

In a possible embodiment, a format of the lyric information may be “[starting time, duration] content of the i^{th} sentence of the lyrics”, where the starting time is a starting time position of the sentence in the target song, and the duration is time occupied by the sentence when it is played, for example, {[0000, 0450] the first sentence of the lyrics, [0450, 0500] the second sentence of the lyrics, [0950, 0700] the third sentence of the lyrics, [1650, 0500] the fourth sentence of the lyrics}. The “0000” in “[0000, 0450] the first sentence of the lyrics” means that “the first sentence of the lyrics” starts from the 0^{th} millisecond of the target song, and “0450” means that “the first sentence of the lyrics” lasts for 450 ms. The “0450” in “[0450, 0500] the second sentence of the lyrics” means that “the second sentence of the lyrics” starts from the 450^{th} millisecond of the target song, and “0500” means that “the second sentence of the lyrics” lasts for 500 ms. The meaning of the last two sentences of the lyrics is the same as the meaning of “[0000, 0450] the first sentence of the lyrics” and “[0450, 0500] the second sentence of the lyrics”, which will not be repeated here.

In a possible embodiment, the format of the lyric information may be “[starting time, duration] the first word in a certain sentence of the lyrics (starting time, duration)”, where the starting time in square brackets indicates a starting time of a certain sentence of the lyrics in the entire song, the duration in square brackets indicates the time occupied by the sentence of the lyrics when it is played, the starting time in parentheses indicates a starting time of the first word in the sentence of the lyrics, and the duration in parentheses indicates the time occupied by the word when it is played.

For example, a certain lyric includes a sentence: “but still think about the smile of you”, and a lyric format corresponding to the sentence is: [264,2686] but (264,188) still (453,268) think (721,289) about (1009,328) the (1337,207) smile (1545,391) of (1936,245) you (2181,769). 264 in the square brackets indicates that the lyric starts from 264 ms in the entire song, and 2686 indicates that the time occupied by the lyric when it is played is 2686 ms. Taking the word “still” as an example, the corresponding 453 indicates that the word “still” starts from 453 ms in the entire song, and 268 indicates that the time occupied by the word “still” when the lyric “but still think about the smile of you” is played is 268 ms.

In a possible embodiment, the format of the lyric information may be “(starting time, duration) a certain word”. The starting time in parentheses indicates a starting time of a certain word in the target song, and the duration in parentheses indicates the time occupied by the word when it is played.

For example, a certain lyric includes a sentence “but still think about the smile of you”, and a lyric format corresponding to the sentence is: (264,188) but (453,268) still (721,289) think (1009,328) about (1337,207) the (1545,391) smile (1936,245) of (2181,769) you. 264 in the first parenthesis indicates that the word “but” starts from 264 ms in the target song, and 188 in the first parenthesis indicates that the word “but” occupies 188 ms when it is played.

At 204, the server renders a subtitle in the target video data based on the lyric information corresponding to the target song and the time position of the song audio signal in the target song to obtain target video data with a subtitle.

In a possible embodiment, the server renders the subtitle in the target video data based on the lyric information corresponding to the target song and the time position of the song audio signal in the target song to obtain the target video data with the subtitle specifically as follows. The server determines a subtitle content corresponding to the song audio signal and the time information of the subtitle content in the target video data based on the lyric information corresponding to the target song and the time position of the song audio signal in the target song. The server renders the subtitle in the target video data based on the subtitle content corresponding to the song audio signal and the time information of the subtitle content in the target video data to obtain the target video data with the subtitle.

Optionally, the time information of the subtitle content in the target video data may be a starting time and duration of a sentence of the lyrics in the target video data and/or a starting time and duration of each word in a sentence of the lyrics in the target video data.

For example, the lyric information corresponding to the target song is {[0000, 0450] the first sentence of the lyrics, [0450, 0500] the second sentence of the lyrics, [0950, 0700] the third sentence of the lyrics, [1650, 0500] the fourth sentence of the lyrics}, and the time position of the song audio signal in the target song is from 450 ms to 2150 ms. The lyrics from 450 ms to 2150 ms are the second sentence of the lyrics, the third sentence of the lyrics, and the fourth sentence of the lyrics, so that the subtitle content corresponding to the song audio signal is the second sentence of the lyrics, the third sentence of the lyrics, and the fourth sentence of the lyrics. The time position (450 ms to 2150 ms) of the song audio signal in the target song is converted to a time position of the song audio signal on a time axis of the target video data. Then time information of the subtitle content on the time axis of the target video data is: from 100 ms to 1700 ms. That is, [0450, 0500] corresponding to the second sentence of the lyrics is converted to [0100, 0500], the [0950, 0700] corresponding to the third sentence of the lyrics is converted to [0600, 0700], and the [1650, 0500] corresponding to the fourth sentence of the lyrics is converted to [1300, 0500]. It can be seen that the duration of the sentence is not changed, but the starting time of the sentence is changed due to the conversion.

Based on the possible embodiment, target lyric information corresponding to the song audio signal is converted into the subtitle content, and the time position of the song audio signal in the target song is converted into time information in the target video data. In this way, in a process of subtitle generation, a generated subtitle is more consistent with the song audio signal and is more accurate.

In a possible embodiment, the server renders the subtitle in the target video data based on the subtitle content corresponding to the song audio signal and the time information of the subtitle content in the target video data to obtain the target video data with the subtitle specifically as follows. The server draws the subtitle content as one or more subtitle pictures based on a target font configuration file. The server renders the subtitle in the target video data based on one or more subtitle pictures and the time information of the subtitle content in the target video data to obtain the target video data with the subtitle.

Optionally, the target font configuration file may be a preset default font configuration file or may be selected by the user from multiple candidate font configuration files through a terminal or other means. The target font configuration file can configure the font, size, color, character spacing, stroke effect (stroke size and color), shadow effect (shadow radius, offset, and color), and maximum length of a single line (if the length of text information exceeds the width of a screen, the text needs to be split into multiple lines) for a text used in a subtitle. The target font configuration file may be a json text. For example, if the user clicks on the terminal device to select that font of a text is pink, a corresponding text color column in a json text corresponding to the target font configuration file is pink (such as “color”: “pink”), and the color of a text in the subtitle picture drawn based on the target font configuration file is pink.

In the possible embodiment, in the process of drawing the subtitle content as one or more subtitle pictures based on the target font configuration file, each sentence of the lyrics in the subtitle content may be drawn as a subtitle picture, as illustrated in FIG. 6 which illustrates a subtitle picture corresponding to a certain sentence of the lyrics. When the length of a sentence of the lyrics is too long and exceeds the width that the screen can display, the sentence of the lyrics is split into two lines. The two lines of the sentence of the lyrics may be drawn as one picture, or may be drawn separately as two pictures, that is, a subtitle picture can be a line of lyrics. For example, a certain sentence of the lyrics is “we are still the same as old days, accompanied with a stranger”. The lyrics cannot be fully displayed using one line on the screen, so the sentence of the lyrics is split into two lines: “we are still the same as old days” and “accompanied with a stranger”. “We are still the same as old days” and “accompanied with a stranger” may be drawn as one subtitle picture. Alternatively, “we are still the same as old days” may be drawn as one subtitle picture, and “accompanied with a stranger” may be drawn as another subtitle picture.

In a possible embodiment, the subtitle content may be drawn as multiple subtitle pictures as follows. Multiple subtitle contents may be drawn simultaneously with multithreading, so that the subtitle pictures can be generated more quickly.

In a possible embodiment, the server may further receive the target video data and a font configuration file identifier sent by the terminal device, and obtain the target font configuration file corresponding to the font configuration file identifier from multiple preset font configuration files.

In the possible implementation, the user may select a font configuration file for generating the subtitle for the video data when uploading the video data. When the terminal device uploads the video data, the terminal device also uploads the font configuration file identifier, which makes it convenient for the user to customize a subtitle style.

For example, when uploading data on the terminal device, the user selects an option for the effect of subtitle rendering. The terminal device converts the option selected by the user into the font configuration file identifier. When the terminal device uploads the video data to the server, the font configuration file identifier is carried. The server determines the target font profile corresponding to the font configuration file identifier from multiple preset font configuration files based on the font configuration file identifier.

Based on the possible embodiment, the corresponding target font configuration file is determined through the font configuration file identifier, so as to achieve the purpose of rendering according to the rendering effect selected by the user.

In a possible embodiment, the server renders the subtitle in the target video data based on the one or more subtitle pictures and the time information of the subtitle content in the target video data to obtain the target video data with the subtitle specifically as follows. The server determines position information of one or more subtitle pictures in a video frame of the target video data. The server renders the subtitle in the target video data based on the one or more subtitle pictures, the time information of the subtitle content in the target video data, and the position information of the one or more subtitle pictures in the video frame of the target video data, to obtain the target video data with the subtitle.

Optionally, the position information of the subtitle picture in the video frame of the target video data includes position information of each word in the subtitle picture in the video frame of the target video data.

The target video data may include multiple video frames included in the target video data. The target video data is formed by switching the multiple video frames at high speed, so that a static picture is visually dynamic.

Optionally, a text in a first subtitle picture is first rendered in a video frame corresponding to the target video data according to time information and position information of the first subtitle picture, and then a text in a second subtitle picture is rendered in a video frame corresponding to the target video data according to time information and position information of the second subtitle picture, and so on, until texts in all subtitle pictures are rendered into the video frame corresponding to the target video data.

Optionally, the server may first render the text in the first subtitle picture in the video frame corresponding to the target video data according to the time information and the position information of the first subtitle picture, and then perform special effects rendering (for example, gradient coloring, gradual appearance, scrolling broadcast, font jumping, etc.) on the text in the first subtitle picture word by word according to time information and position information of each word contained in the first subtitle picture. When rendering of the text in the first subtitle picture is finished, the server may render the text in the second subtitle picture in the video frame corresponding to the target video data, and then perform special effects rendering on the text in the second subtitle picture word by word according to time information and position information of each word contained in the second subtitle picture, and so on, until texts in all subtitle pictures are rendered into the video frame corresponding to the target video data, for example, as illustrated in FIG. 7.

Based on the possible embodiment, a corresponding position of the subtitle picture in the video frame of the target video data is determined, so that a corresponding subtitle content is accurately rendered at a corresponding time.

The method for generating a subtitle provided in the disclosure is further described as follows with a specific example.

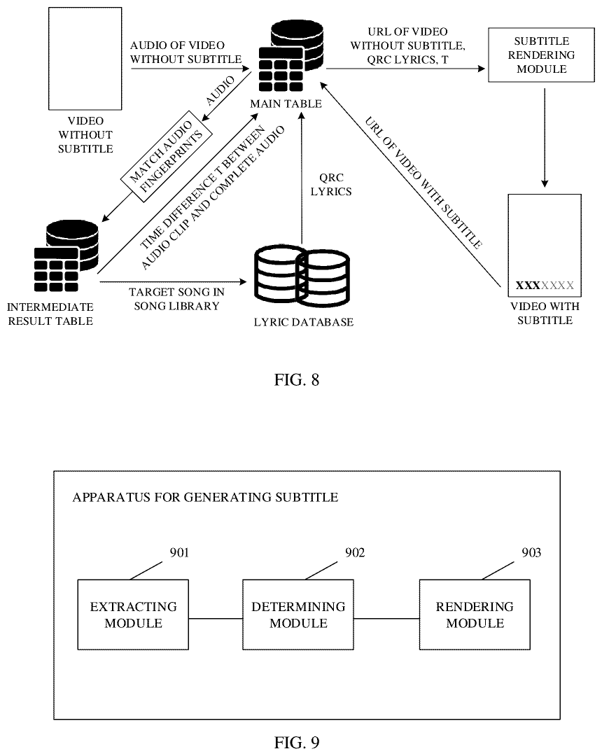

Reference is made to FIG. 8 which is a schematic diagram of a method for generating a subtitle provided in the solution. The server extracts audio of a video without a subtitle from the video without a subtitle (target video data). The server extracts an audio fingerprint of the audio from the audio of the video without a subtitle. The server matches the audio fingerprint with an intermediate result table (fingerprint database) to obtain a matched song (target song) and a time difference (i.e., the time position of the song audio signal in the target song) between an audio clip and complete audio. The server finds out, in a lyric database (lyric library) according to the matched song, corresponding (Qt Recources file, QRC) lyrics (lyric information) synchronously displayed in the QQ Music Player™. The server puts the QRC lyrics, the time difference between the audio clip and the complete audio, and the video without a subtitle into a subtitle rendering module (perform rendering in the target video data) to obtain the video with the subtitle. A uniform resource locator (URL) address of the video with the subtitle can be written into a main table.

Reference is made to FIG. 9 which is a schematic structural diagram of an apparatus for generating a subtitle provided in embodiments of the disclosure. The apparatus for generating a subtitle provided in embodiments of the disclosure includes an extracting module 901, a determining module 902, and a rendering module 903.

The extracting module 901 is configured to extract a song audio signal from target video data.

The determining module 902 is configured to determine a target song corresponding to the song audio signal and a time position of the song audio signal in the target song.

The determining module 902 is further configured to obtain lyric information corresponding to the target song, where the lyric information includes one or more lyrics, and the lyric information further includes a starting time and duration of each lyric and/or a starting time and duration of each word in each lyric.

The rendering module 903 is configured to render a subtitle in the target video data based on the lyric information and the time position to obtain target video data with a subtitle.

In another embodiment, the determining module 902 is further configured to convert the song audio signal into speech spectrum information. The determining module 902 is further configured to determine fingerprint information of the song audio signal based on a peak point in the speech spectrum information. The determining module 902 is further configured to match the fingerprint information of the song audio signal with song fingerprint information in a song fingerprint database to determine the target song corresponding to the song audio signal and the time position of the song audio signal in the target song.

In another embodiment, the determining module 902 is further configured to match the fingerprint information of the song audio signal with the song fingerprint information in the song fingerprint database in descending order of popularity based on a song popularity ranking order corresponding to the song fingerprint information in the song fingerprint database.

In another embodiment, the determining module 902 is further configured to identify gender of a singer of the song audio signal. The fingerprint information of the song audio signal is matched with the song fingerprint information in the song fingerprint database as follows. The determining module 902 is further configured to match the fingerprint information of the song audio signal with song fingerprint information corresponding to the gender of the singer in the song fingerprint database.

In another embodiment, the determining module 902 is further configured to determine a subtitle content corresponding to the song audio signal and time information of the subtitle content in the target video data based on the lyric information corresponding to the target song and the time position of the song audio signal in the target song.

The rendering module 903 is further configured to render the subtitle in the target video data based on the subtitle content corresponding to the song audio signal and the time information of the subtitle content in the target video data to obtain the target video data with the subtitle.

In another embodiment, the rendering module 903 is further configured to draw the subtitle content as one or more subtitle pictures based on a target font configuration file. The rendering module 903 is further configured to render the subtitle in the target video data based on the one or more subtitle pictures and the time information of the subtitle content in the target video data to obtain the target video data with the subtitle.

In another embodiment, the rendering module 903 is further configured to determine position information of the one or more subtitle pictures in a video frame of the target video data. The rendering module 903 renders the subtitle in the target video data based on the one or more subtitle pictures, the time information of the subtitle content in the target video data, and the position information of the one or more subtitle pictures in the video frame of the target video data, to obtain the target video data with the subtitle.

In another embodiment, the determining module 902 is further configured to receive the target video data and a font configuration file identifier sent by a terminal device. The determining module 902 is further configured to obtain the target font configuration file corresponding to the font configuration file identifier from multiple preset font configuration files.

It is understood that functions of various functional units of the apparatus for generating a subtitle provided in embodiments of the disclosure can be specifically implemented according to the method in the above method embodiments. The specific implementation process can refer to the relevant description in the above method embodiments, which will not be repeated here.

In a possible embodiment, the apparatus for generating a subtitle provided in embodiments of the disclosure can be implemented in software. The apparatus for generating a subtitle can be stored in a memory, which can be software in the form of a program and a plug-in, and includes a series of units, including an obtaining unit and a processing unit. The obtaining unit and the processing unit are configured to implement the method for generating a subtitle provided in embodiments of the disclosure.

In other possible embodiments, the apparatus for generating a subtitle provided in embodiments of the disclosure may be implemented in a combination of software and hardware. As an example, the apparatus for generating a subtitle provided in embodiments of the disclosure may be a processor in the form of a hardware decoding processor, which is programmed to perform the method for generating a subtitle provided in embodiments of the disclosure. For example, the processor in the form of the hardware decoding processor may have one or more application specific integrated circuits (ASICs), DSPs, programmable logic devices (PLDs), complex programmable logic devices (CPLDs), field programmable gate arrays (FPGAs), or other electronic components.

In embodiments of the disclosure, the apparatus for generating a subtitle matches the fingerprint information of the song audio signal extracted from the target video data with the fingerprint database to obtain an identifier corresponding to the song audio signal and the time position in the target song, and then determines a corresponding lyric according to the identifier. The subtitle is rendered for the target video data according to the lyric and the time position. In embodiments of the disclosure, the subtitle can be automatically and conveniently generated for the music short video, which can improve the efficiency of subtitle generation.

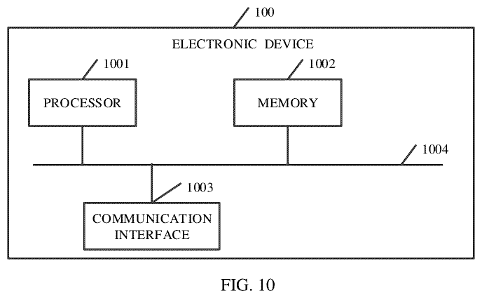

Reference is made to FIG. 10 which is a schematic structural diagram of an electronic device provided in embodiments of the disclosure. The electronic device 100 can include a processor 1001, a memory 1002, a communication interface 1003, and at least one communication bus 1004. The processor 1001 is configured to schedule computer programs, and may include a central processing unit (CPU), a controller, and a microprocessor. The memory 1002 is configured to store computer programs, and may include a high-speed random access memory (RAM), a non-volatile memory such as a disk storage device and a flash memory device. The communication interface 1003 may optionally include a standard wired interface, and a wireless interface (such as a WI-FI interface) and provide data communication functions. The communication bus 1004 is configured to connect various communication components. The electronic device 100 may correspond to the electronic device 100 mentioned above. The memory 1002 is configured to store computer programs, and the computer programs include program instructions. The processor 1001 is configured to execute the program instructions stored in the memory 1002 to perform the process described in operations at S201 to S204 in the above embodiments, and perform the following operations.

In an implementation, a song audio signal is extracted from target video data.

A target song corresponding to the song audio signal and a time position of the song audio signal in the target song are determined.

Lyric information corresponding to the target song is obtained, where the lyric information includes one or more lyrics, and the lyric information further includes a starting time and duration of each lyric and/or a starting time and duration of each word in each lyric.

Based on the lyric information and the time position, a subtitle is rendered in the target video data to obtain target video data with a subtitle.

In a specific implementation, the above-mentioned electronic device can perform the embodiment provided in various operations in FIG. 1 to FIG. 8 via built-in functional modules of the electronic device. For details, please refer to the embodiments provided in the above-mentioned operations, which will not be repeated here.

Embodiments of the disclosure further provide a non-transitory computer-readable storage medium which stores computer programs. The computer programs include program instructions. The program instructions, when executed by a processor, are operable to implement a fundamental frequency prediction method provided in each operation in FIG. 8. For details, please refer to the embodiments provided in the above operations, which will not be repeated here.

The above-mentioned non-transitory computer-readable storage medium may be an internal storage unit of an apparatus for training a recommendation model provided in any of the aforementioned embodiments or the above-mentioned terminal device, such as a hard disk or memory of an electronic device. The non-transitory computer-readable storage medium may further be an external storage device of the electronic device, such as a plug-in hard disk, a smart media card (SMC), a secure digital (SD) card, a flash card, and so on equipped on the electronic device. Furthermore, the non-transitory computer-readable storage medium may further include both the internal storage unit and the external storage device of the electronic device. The non-transitory computer-readable storage medium is configured to store the computer programs and other programs and data required by the electronic device. The non-transitory computer-readable storage medium may further be configured to temporarily store data that has been output or is to be output.

The terms “first”, “second”, “third”, “fourth”, and so on in the claims, specification, and drawings of the disclosure are used to distinguish different objects, rather than to describe a specific order. In addition, the terms “including” and “having” and any variations thereof are intended to cover non-exclusive inclusions. For example, a process, method, system, product or device that includes a series of operations or units is not limited to the listed operations or units, but optionally includes operations or units that are not listed, or optionally includes other operations or units inherent to these processes, methods, products or devices.

In a specific implementation of the disclosure, data related to user information (such as target video data, etc.) is involved. When the above embodiments of the disclosure are applied to specific products or technologies, user permission or consent is required, and the collection, use, and processing of relevant data must comply with relevant laws, regulations, and standards of relevant countries and regions.

Mentioning “embodiment” in the disclosure means that specific features, structures, or characteristics described in conjunction with embodiments may be included in at least one embodiment of the disclosure. Displaying of the phrase at various locations in the specification does not necessarily refer to the same embodiment, nor is it an independent or alternative embodiment that is mutually exclusive with other embodiments. It is explicitly and implicitly understood by those of ordinary skill in the art that embodiments described herein may be combined with other embodiments. The term “and/or” used in the specification of the disclosure and the appended claims refers to any combination of one or more of the items listed in association and all possible combinations, and includes these combinations. It can be appreciated by those of ordinary skill in the art that the units and algorithm operations of each example described in conjunction with embodiments disclosed herein can be implemented in electronic hardware, computer software, or a combination of the two. In order to clearly illustrate the interchangeability of hardware and software, the composition and operations of each example have been generally described in the above description according to the function. Whether these functions are performed in hardware or software depends on a specific application and design constraints of the technical solution. Professional and technical personnel can use different methods to implement the described functions for each specific application, but such implementation should not be considered to exceed the scope of the disclosure.

The method and related apparatus provided in embodiments of the disclosure are described with reference to a method flow chart and/or structural diagram provided in embodiments of the disclosure, and can be specifically implemented by computer program instructions for each process and/or box of the method flow chart and/or structural diagram, and the combination of the process and/or box in the flow chart and/or block diagram. These computer program instructions can be provided to a processor of a general-purpose computer, a special-purpose computer, an embedded processor, or other programmable data processing device to produce a machine, so that the instructions executed by the processor of the computer or other programmable data processing device produce an apparatus for realizing the function specified in one or more processes of the flow chart and/or one box or multiple boxes of the structural diagram. These computer program instructions can also be stored in a non-transitory computer-readable memory that can guide a computer or other programmable data processing device to work in a specific manner, so that the instructions stored in the non-transitory computer-readable memory produce a product including an instruction apparatus which implements the function specified in one or more processes of the flow chart and/or one box or multiple boxes of the structural diagram. These computer program instructions may further be loaded onto a computer or other programmable data processing device so that a series of operational operations are executed on the computer or other programmable device to produce a computer-implemented process, whereby the instructions executed on the computer or other programmable device provide operations for implementing the functions specified in one or more processes in the flow chart and/or one or more boxes in the structure diagram.

What is claimed is:

1. A method for generating a subtitle, comprising:
extracting a song audio signal from target video data;
determining a target song corresponding to the song audio signal and a time position of the song audio signal in the target song;
obtaining lyric information corresponding to the target song, wherein the lyric information comprises one or more lyrics, and the lyric information further comprises a starting time and duration of each lyric and/or a starting time and duration of each word in each lyric; and
rendering a subtitle in the target video data based on the lyric information and the time position to obtain target video data with a subtitle.

2. The method of claim 1, wherein determining the target song corresponding to the song audio signal and the time position of the song audio signal in the target song comprises:
converting the song audio signal into speech spectrum information;
determining fingerprint information of the song audio signal based on a peak point in the speech spectrum information; and
matching the fingerprint information of the song audio signal with song fingerprint information in a song fingerprint database to determine the target song corresponding to the song audio signal and the time position of the song audio signal in the target song.

3. The method of claim 2, wherein matching the fingerprint information of the song audio signal with the song fingerprint information in the song fingerprint database comprises:
matching, in descending order of popularity, the fingerprint information of the song audio signal with the song fingerprint information in the song fingerprint database based on a song popularity ranking order corresponding to the song fingerprint information in the song fingerprint database.

4. The method of claim 2, further comprising:
identifying gender of a singer of the song audio signal; and
matching the fingerprint information of the song audio signal with the song fingerprint information in the song fingerprint database comprises:
matching the fingerprint information of the song audio signal with song fingerprint information corresponding to the gender of the singer in the song fingerprint database.

5. The method of claim 1, wherein rendering the subtitle in the target video data based on the lyric information corresponding to the target song and the time position of the song audio signal in the target song to obtain the target video data with the subtitle comprises:
determining a subtitle content corresponding to the song audio signal and time information of the subtitle content in the target video data based on the lyric information corresponding to the target song and the time position of the song audio signal in the target song; and
rendering the subtitle in the target video data based on the subtitle content corresponding to the song audio signal and the time information of the subtitle content in the target video data to obtain the target video data with the subtitle.

6. The method of claim 5, wherein rendering the subtitle in the target video data based on the subtitle content corresponding to the song audio signal and the time information of the subtitle content in the target video data to obtain the target video data with the subtitle comprises:
drawing the subtitle content as one or more subtitle pictures based on a target font configuration file; and
rendering the subtitle in the target video data based on the one or more subtitle pictures and the time information of the subtitle content in the target video data to obtain the target video data with the subtitle.

7. The method of claim 6, wherein rendering the subtitle in the target video data based on the one or more subtitle pictures and the time information of the subtitle content in the target video data to obtain the target video data with the subtitle comprises:
determining position information of the one or more subtitle pictures in a video frame of the target video data; and
rendering the subtitle in the target video data based on the one or more subtitle pictures, the time information of the subtitle content in the target video data, and the position information of the one or more subtitle pictures in the video frame of the target video data, to obtain the target video data with the subtitle.

8. The method of claim 6, further comprising:
receiving the target video data and a font configuration file identifier sent by a terminal device; and
obtaining the target font configuration file corresponding to the font configuration file identifier from a plurality of preset font configuration files.

9. An electronic device comprising a processor, a communication interface, and a memory, wherein the processor, the communication interface, and the memory are connected to each other, wherein the memory is configured to store executable program codes, and the processor is configured to invoke the executable program codes to:
extract a song audio signal from target video data;
determine a target song corresponding to the song audio signal and a time position of the song audio signal in the target song;
obtain lyric information corresponding to the target song, wherein the lyric information comprises one or more lyrics, and the lyric information further comprises a starting time and duration of each lyric and/or a starting time and duration of each word in each lyric; and
render a subtitle in the target video data based on the lyric information and the time position to obtain target video data with a subtitle.

10. The electronic device of claim 9, wherein in terms of determining the target song corresponding to the song audio signal and the time position of the song audio signal in the target song, the processor is configured to invoke the executable program codes to:
convert the song audio signal into speech spectrum information;
determine fingerprint information of the song audio signal based on a peak point in the speech spectrum information; and
match the fingerprint information of the song audio signal with song fingerprint information in a song fingerprint database to determine the target song corresponding to the song audio signal and the time position of the song audio signal in the target song.

11. The electronic device of claim 10, wherein in terms of matching the fingerprint information of the song audio signal with the song fingerprint information in the song fingerprint database, the processor is configured to invoke the executable program codes to:
match, in descending order of popularity, the fingerprint information of the song audio signal with the song fingerprint information in the song fingerprint database based on a song popularity ranking order corresponding to the song fingerprint information in the song fingerprint database.

12. The electronic device of claim 10, wherein the processor is configured to invoke the executable program codes to:
identify gender of a singer of the song audio signal; and
in terms of matching the fingerprint information of the song audio signal with the song fingerprint information in the song fingerprint database, the processor is configured to invoke the executable program codes to:
match the fingerprint information of the song audio signal with song fingerprint information corresponding to the gender of the singer in the song fingerprint database.

13. The electronic device of claim 9, wherein in terms of rendering the subtitle in the target video data based on the lyric information corresponding to the target song and the time position of the song audio signal in the target song to obtain the target video data with the subtitle, the processor is configured to invoke the executable program codes to:
determine a subtitle content corresponding to the song audio signal and time information of the subtitle content in the target video data based on the lyric information corresponding to the target song and the time position of the song audio signal in the target song; and
render the subtitle in the target video data based on the subtitle content corresponding to the song audio signal and the time information of the subtitle content in the target video data to obtain the target video data with the subtitle.

14. The electronic device of claim 13, wherein in terms of rendering the subtitle in the target video data based on the subtitle content corresponding to the song audio signal and the time information of the subtitle content in the target video data to obtain the target video data with the subtitle, the processor is configured to invoke the executable program codes to:
draw the subtitle content as one or more subtitle pictures based on a target font configuration file; and
render the subtitle in the target video data based on the one or more subtitle pictures and the time information of the subtitle content in the target video data to obtain the target video data with the subtitle.

15. The electronic device of claim 14, wherein in terms of rendering the subtitle in the target video data based on the one or more subtitle pictures and the time information of the subtitle content in the target video data to obtain the target video data with the subtitle, the processor is configured to invoke the executable program codes to:
determine position information of the one or more subtitle pictures in a video frame of the target video data; and
render the subtitle in the target video data based on the one or more subtitle pictures, the time information of the subtitle content in the target video data, and the position information of the one or more subtitle pictures in the video frame of the target video data, to obtain the target video data with the subtitle.

16. The electronic device of claim 14, wherein the processor is configured to invoke the executable program codes to:
receive the target video data and a font configuration file identifier sent by a terminal device; and
obtain the target font configuration file corresponding to the font configuration file identifier from a plurality of preset font configuration files.

17. A non-transitory computer-readable storage medium storing a computer program which, when run on a computer, is operable with the computer to:
extract a song audio signal from target video data;
determine a target song corresponding to the song audio signal and a time position of the song audio signal in the target song;
obtain lyric information corresponding to the target song, wherein the lyric information comprises one or more lyrics, and the lyric information further comprises a starting time and duration of each lyric and/or a starting time and duration of each word in each lyric; and
render a subtitle in the target video data based on the lyric information and the time position to obtain target video data with a subtitle.

18. The non-transitory computer-readable storage medium of claim 17, wherein in terms of determining the target song corresponding to the song audio signal and the time position of the song audio signal in the target song, the computer program is operable with the computer to:
convert the song audio signal into speech spectrum information;
determine fingerprint information of the song audio signal based on a peak point in the speech spectrum information; and
match the fingerprint information of the song audio signal with song fingerprint information in a song fingerprint database to determine the target song corresponding to the song audio signal and the time position of the song audio signal in the target song.

19. The non-transitory computer-readable storage medium of claim 18, wherein in terms of matching the fingerprint information of the song audio signal with the song fingerprint information in the song fingerprint database, the computer program is operable with the computer to:
match, in descending order of popularity, the fingerprint information of the song audio signal with the song fingerprint information in the song fingerprint database based on a song popularity ranking order corresponding to the song fingerprint information in the song fingerprint database.

20. The non-transitory computer-readable storage medium of claim 18, wherein the computer program is operable with the computer to:
identify gender of a singer of the song audio signal; and
in terms of matching the fingerprint information of the song audio signal with the song fingerprint information in the song fingerprint database, the computer program is operable with the computer to:
match the fingerprint information of the song audio signal with song fingerprint information corresponding to the gender of the singer in the song fingerprint database.
